(19) United States
(12) Patent Application Publication
(10) Pub. No.: US 2011/0039575 A1
(43) Pub. Date: Feb. 17, 2011

(54) METHOD AND SYSTEM FOR POSITIONING NEIGHBOR CELLS IN A CELLULAR NETWORK USING LEARNED CELL DATA

(76) Inventors: Manuel Del Castillo, Madrid (ES); Steve Malkos, San Jose, CA (US); David Albert Lundgren, Mill Valley, CA (US); Vladimir Belov, Union City, CA (US); Alexander Usach, San Francisco, CA (US); Andrei Kosolobov, San Jose, CA (US); James William Lamance, Hixson, TN (US)

Correspondence Address: MCANDREWS HELD & MALLOY, LTD, 500 WEST MADISON STREET, SUITE 3400, CHICAGO, IL, 60661, US

(21) Appl. No.: 12/757,682

(22) Filed: Apr. 9, 2010

Related U.S. Application Data
(60) Provisional application No. 61/234,006, filed on Aug. 14, 2009.

(51) Int. Cl. H04W 64/00

(52) U.S. Cl. 455/456.1

(57) ABSTRACT

A mobile device learns cell information for a serving cell and for neighbor cells. The learned cell information is communicated to a remote location server for locating base stations within the serving and/or neighbor cells. The learned cell information comprises cell signal strength information and/or other cell information such as cell identifiers (Cell-IDs) and Country Code (MCC). Received signal strength (RSS) on the serving cell and the neighbor cells are measured. Locations pertaining to the RSS measurements are determined. The mobile device location stamps the RSS measurements utilizing the determined locations to generate a neighbor cell report, which is utilized by a cellular communication network to prepare a handover operation whenever needed, and/or to build a local cell-learning database. A portion of the local cell-learning database is transmitted as cell data to the remote location server that collects cell data from a plurality of mobile devices.

### CROSS-REFERENCE TO RELATED APPLICATIONS/INCORPORATION BY REFERENCE

This patent application makes reference to, claims priority to, and claims the benefit from U.S. Provisional Patent Application Ser. No. 61/234,006 filed on Aug. 14, 2009.

This application also makes reference to:
U.S. application Ser. No. 12/394,416 filed on Feb. 27, 2009;
U.S. application Ser. No. 12/607,266 filed on Oct. 28, 2009;
U.S. application Ser. No. 12/690,007 filed on Jan. 10, 2010;
U.S. Application Ser. No. 61/304,024 filed on Feb. 12, 2010;
U.S. Application Ser. No. 61/304,205 filed on Feb. 12, 2010;
U.S. Application Ser. No. 61/304,253 filed on Feb. 12, 2010;
U.S. Application Ser. No. 61/306,387 filed on Feb. 19, 2010;
U.S. Application Ser. No. 61/304,210 filed on Feb. 12, 2010;
U.S. application Ser. No. 12/748,177 filed on Mar. 26, 2010;
U.S. application Ser. No. 12/748,240 filed on Mar. 26, 2010;
U.S. application Ser. No. 12/748,212 filed on Mar. 26, 2010;
U.S. application Ser. No. 12/748,194 filed on Mar. 26, 2010;
U.S. application Ser. No. 12/729,197 filed on Mar. 22, 2010; and
U.S. application Ser. No. 12/729,184 filed on Mar. 22, 2010.

Each of the above stated applications is hereby incorporated herein by reference in its entirety.

### FIELD OF THE INVENTION

Certain embodiments of the invention relate to signal processing for communication systems. More specifically, certain embodiments of the invention relate to a method and system for positioning neighbor cells in a cellular network using learned cell data.

### BACKGROUND OF THE INVENTION

Location based services (LBS) are emerging as a value-added service provided by mobile communication network. LBS are mobile services in which the user location information is used in order to enable various LBS applications such as, for example, enhanced 911 (E-911) services. A position of a mobile device is determined in different ways such as, for example, using network-based technology, using terminal-based technology, and/or hybrid technology (a combination of the former technologies). Many positioning technologies such as, for example, Cell of Origin (COO), Time of Arrival (TOA), Observed Time Difference of Arrival (OTDOA), Enhanced Observed Time Difference (E-OTD) as well as the satellite-based systems such as the global positioning system (GPS), or Assisted-GPS (A-GPS), are in place to estimate the location of the mobile device and convert it into a meaningful X, Y coordinate for LBS applications.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for positioning neighbor cells in a cellular network using learned cell data, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary communication system that is operable to locate neighbor cells in a cellular network using learned cell data, in accordance with an embodiment of the invention.

FIG. 2 is a diagram illustrating an exemplary mobile device that is operable to provide cell data to a cell-learning database for neighbor cell positioning, in accordance with an embodiment of the invention.

FIG. 3 is a diagram illustrating an exemplary location server that is operable to locate neighbor cells using learned cell data provided by associated mobile devices, in accordance with an embodiment of the invention.

FIG. 4 is a diagram illustrating exemplary steps utilized by a mobile device to generate Neighbor Cell Reports to build a cell-learning database, in accordance with an embodiment of the invention.

FIG. 5 is a diagram illustrating exemplary steps utilized by a location server to collect cell data from mobile devices in a cellular network to build a central cell-learning database, in accordance with an embodiment of the invention.

FIG. 6 is a diagram illustrating exemplary steps utilized by a location server to locate a specific cell utilizing corresponding cell data received from mobile devices in a cellular network, in accordance with an embodiment of the invention.

FIG. 7 is a diagram illustrating exemplary steps utilized by a location server to determine ranges to reported neighbor cells for a specific mobile device, in accordance with an embodiment of the invention.

### DETAILED DESCRIPTION OF THE INVENTION

Certain embodiments of the invention may be found in a method and system for positioning neighbor cells in a cellular network using learned cell data. In accordance with various exemplary embodiments of the invention, a mobile device in a cellular communication network is operable to collect or learn cell information on a serving cell and one or more neighbor cells of the mobile device. The learned cell information may be transmitted or communicated to a remote location server. The remote location server may be operable to utilize the learned cell information to determine a location of a corresponding base station in the serving cell and/or to determine locations of corresponding base stations within the one or more neighbor cells. The mobile device is operable to receive the location of a corresponding base station in the serving cell and/or corresponding base stations within the one or more neighbor cells. The learned cell information comprises cell signal strength information and other cell information such as, for example, cell operating frequencies, cell identifiers (Cell-IDs), Country Code (MCC), and/or Mobile Network Code (MNC). In this regard, the mobile device may be operable to collect or learn cell signal strength information by measuring received signal strength (RSS) on the serving cell and the neighbor cells. Locations pertaining to the RSS measurements may be determined through GNSS or non-GNSS means based on device capabilities. The RSS measurements may be location stamped utilizing the determined locations. The mobile device may utilize the location-stamped RSS measurements together with other captured cell information such as Cell-IDs to generate a neighbor cell report. The generated neighbor cell report may be utilized for various applications such as, for example, to communicate the generated neighbor cell report to the cellular communication network to prepare a handover operation whenever needed, and/or to build a local cell-learning database. In this regard, at least a portion of the local cell-learning database may be transmitted or communicated as cell data to the remote location server to build or refine a central cell-learning database. The remote location server may be operable to collect cell data from a plurality of mobile devices to independently determine locations of corresponding base station within reported cells without the use of location based services provided by a wireless operator.

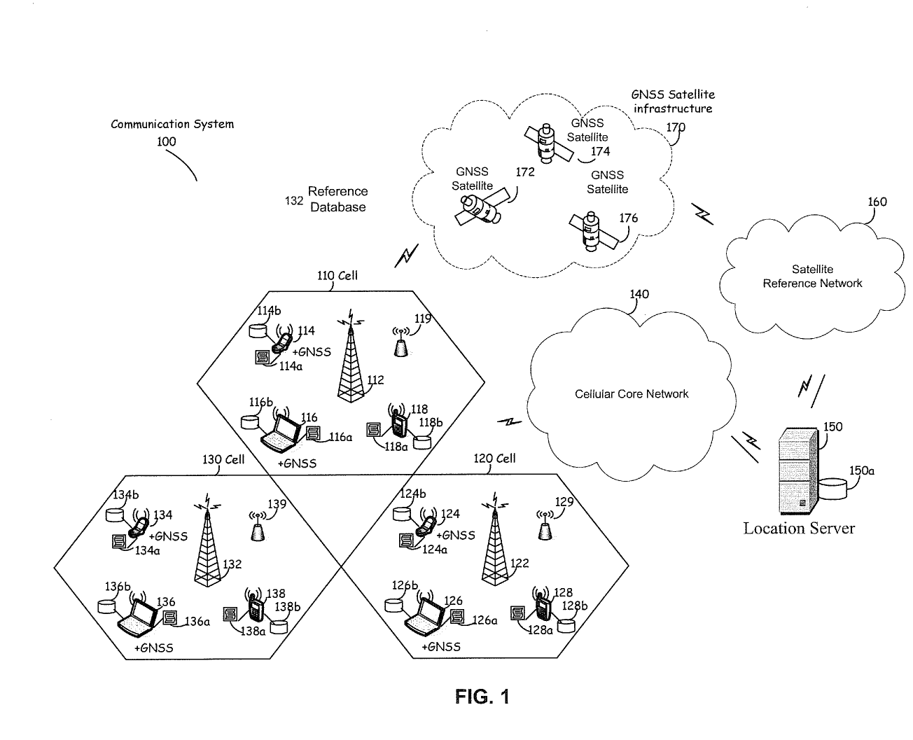

FIG. 1 is a diagram illustrating an exemplary communication system that is operable to locate neighbor cells in a cellular network using learned cell data, in accordance with an embodiment of the invention. Referring to FIG. 1, there is shown a communication system 100. The communication system 100 comprises cells 110-130, a cellular core network 140, a location server 150, a satellite reference network (SRN) 160 and a GNSS satellite infrastructure 170. Each of the cells 110-130 comprises a base station and a plurality of mobile devices, of which base stations 112-132 and mobile devices 114-118, 124-128 and 134-138 are illustrated for the cells 110-130, respectively. The GNSS satellite infrastructure 170 comprises a plurality of visible GNSS satellites, of which GNSS satellites 172-176 are displayed.

The cells 110-130 comprise geographical areas covered or served by the base stations 112, 122 and 132, respectively. A cell such as the cell 110 may be identified by a unique cell identifier (Cell-ID). With regard to each mobile device within the communication system 100, a cell may act as an active cell, a candidate cell or a neighbor cell. For a particular mobile device, an active cell is a cell that is currently connected to the particular mobile device. A candidate cell is a cell that is not currently connected to the particular mobile device, but with associated pilot or reference signals strong enough to be added to an active cell list for the particular mobile device. A neighbor cell is a cell that is continuously measured by the particular mobile device and corresponding pilot or reference signals are not strong enough to be added to the active cell list for the particular mobile device.

A base station such as the base station 112 may comprise suitable logic, circuitry, interfaces and/or code that are operable to manage and schedule communication resources in an uplink direction and/or downlink direction within the cell 110. The base station 112 may be operable to receive and/or transmit radio frequency signals from and/or to mobile devices such as the mobile devices 114-118 using various air interface protocols specified in, for example, CDMA, GSM, UMTS and/or LTE radio access networks. The base station 112 may be operable to deliver or communicate services such as, for example, LBS applications, provided by the cellular core network 140 to intended mobile devices such as the mobile devices 114-118. In this regard, the location of the base station 112, also called the location of the cell 110, may be needed to support desired LBS applications for the mobile device 114-118.

A mobile device such as the mobile device 114 may comprise suitable logic, circuitry, interfaces and/or code that are operable to communicate with the cellular core network via the base station 112. The mobile device 114 may be operable to communicate radio signals that are compatible with various telecommunication standards specified in, for example, CDMA, GSM, UMTS and/or LTE, with the base station 112. The communicated radio signals may comprise services such as LBS applications provided by the cellular core network 140. In this regard, location information such as locations of a serving base station, namely, the base station 112, and/or one or more neighbor base stations such as the base stations 122-132 for the mobile device 114 may be required to support desired LBS applications.

In various embodiments of the invention, a mobile device such as the mobile device 114 may be operable to run a cell-learning client 114a, which may comprise application software and/or firmware, to perform cell-learning. In this regard, the mobile device 114 may be configured to capture cell signal strength information by measuring received signal strength (RSS) on a serving cell, namely, the cell 110, and one or more neighbor cells such as the cells 120-130. The mobile device 114 may be operable to utilize the cell-learning client 114a to associate the RSS measurements with corresponding locations where the RSS measurements are performed. Specifically, the mobile device 114 may be operable to location stamp the RSS measurements utilizing the corresponding locations to form location-based RSS measurements. Depending on device capabilities, a location at a specific time instant for a mobile device may be determined or calculated through GNSS or non-GNSS means. For example, in instances where a mobile device is GNSS capable such as the mobile device 114, GNSS positions for the mobile device 114 may be determined or calculated for corresponding RSS measurements utilizing GNSS signals received from a plurality of visible GNSS satellites such as the GNSS satellites 172 through 176. In instances where a mobile device is non-GNSS capable such as the mobile device 118, a location at a specific time instant for the mobile device 118 may be determined or calculated through various non-GNSS means such as, for example, WiFi-based positioning via encountered wireless access points such as a wireless access point 119 in the cell 110.

U.S. application Ser. No. 12/748,177 filed on Mar. 26, 2010; U.S. application Ser. No. 12/748,240 filed on Mar. 26, 2010; U.S. application Ser. No. 12/748,212 filed on Mar. 26, 2010; U.S. application Ser. No. 12/748,194 filed on Mar. 26, 2010; U.S. application Ser. No. 12/729,197 filed on Mar. 22, 2010; and U.S. application Ser. No. 12/729,184 filed on Mar. 22, 2010, provide detailed descriptions that deal with determining locations utilizing non-GNSS means, each of which is hereby incorporated herein by reference in its entirety.

In addition to cell signal strength information, the mobile device 114 may be operable to run the cell-learning client 114a to learn and/or capture other cell information on both the serving cell, namely, the cell 110, as well as neighbor cells such as the cells 120-130 to facilitate cell-learning. The captured cell information may comprise information such as, for example, cell operating frequencies, cell identifiers (Cell-IDs), location-based RSS measurements, Country Code (MCC) and/or Mobile Network Code (MNC). The cell-learning client 114a may utilize the captured cell information to generate a neighbor cell report (NCR).

The generated NCR may be utilized to support various network operations. For example, the mobile device 114 may be operable to send or communicate the generated NCR as a Network Measurement Report (NMR) (in 2G) or a Measurement Report List (MRL) (in 3G) to the cellular core network 140 via its serving cell, namely, the cell 110, in order to prepare itself for a handover from the serving cell (the cell 110) to a reported neighbor cell such as the cell 120. Furthermore, the mobile device 114 may be operable to utilize the generated NCR to build a local cell-learning database 114b to facilitate cell-learning. In this regard, in order to expedite cell-learning, the local cell-learning database 114b may be operable to index the contents of the generated NCR utilizing a cell attribute parameter. The cell attribute parameter indicates whether a reported cell is a serving cell or a neighbor cell for the mobile device 114. In instances where a reported cell is a serving cell, the local cell-learning database 114b may flag or mark contents associated with the reported serving cell as more accurate. In instances where a reported cell is a neighbor cell, contents associated with the reported neighbor cell may be flagged or marked as less accurate. The local cell-learning database 114b may be updated or refined on an-needed basis, periodically, or aperiodically. At least a portion of the cell-learning database 114b may be uploaded, regularly or on an as-needed basis, as cell data to the location server 150 to build a central cell-learning database 150a. The uploaded cell data may be utilized to accurately locate cells such as the cells 110-130 reported in the uploaded cell data. In other words, the uploaded cell data may be utilized to accurately determine or calculate locations of corresponding base stations in the cells reported in the uploaded cell data. In this regard, the location server 150 may be operable to independently determine or calculate locations for the reported cells without using location based services provided by a wireless operator. The mobile device 114 may receive the determined locations for the reported cells from the location server 150 whenever needed. The format of the uploaded cell data may vary depending on the cellular core network 140. For example, in instances where the cellular core network 140 is a 2G network, the uploaded cell data may comprise CGI, location-based RSS measurements, BCCH ARFCN and BSIC. In instances where the cellular core network is a 3G network, the uploaded cell data may comprise CGI, location-based RSS measurements, and/or Primary Scrambling Code.

The cellular core network 140 may comprise suitable logic, circuitry, interfaces and/or code that are operable to interface various cellular radio access networks such as, for example, a CDMA network, a UMTS network and/or a LTE network, with external data networks such as packet data networks (PDNs). The cellular core network 140 may be operable to communicate with associated cells such as the cells 110-130 to maintain various network operations. For example, the cellular core network 140 may be operable to receive NMRs (in 2G) or MRLs (in 3G) from mobile devices in the cells 110-130. The received NMRs or MRLs may comprise NCRs that report both serving and neighbor cell information captured by mobile devices. The cellular core network 140 may utilize the reported cell information to manage and/or control handover operations whenever needed. Moreover, the cellular core network 140 may be configured to communicate various data services such as location-based services to intended mobile devices such as, for example, the mobile devices 114-138. In this regard, the cellular core network 140 may be operable to communicate with the location server 150 for locations of corresponding cells such as the cells 110-130 required for desired location-based services.

The location server 150 may comprise suitable logic, circuitry and/or code that may be operable to access the satellite reference network (SRN) 160 to collect GNSS satellite data by tracking GNSS constellations through the SRN 160. The location server 150 may be operable to utilize the collected GNSS satellite data to build, for example, the central cell-learning database 150a. The location server 150 may also be operable to receive cell data from a plurality of mobile devices associated with the cellular core network 140. The received cell data may comprise cell information such as, for example, cell operating frequencies, Cell-IDs, location-based RSS measurements, MCC and/or MNC. The format of the received cell data may vary depending on the cellular core network 140. In instance where the cellular core network is a 2G cellular network, the received cell data may comprise CGI, BCCH ARFCN, BSIC and/or location-based RSS measurements. In instance where the cellular core network is a 3G cellular network, the received cell data may comprise CGI, Primary Scrambling Code and/or location-based RSS measurements on CPICH.

In the central cell-learning database 150a, contents associated with a serving cell may be indexed as more accurate compared to contents associated with a neighbor cell. The location server 150 may be operable to utilize the learned cell data in the central cell-learning database 150a to determine or calculate locations for cells reported in the received cell data. In this regard, locations of reported cells may be determined or calculated by the location server 150 independently without using location based services offered by the wireless operator. The determined cell locations may be utilized as reference locations to support assistance GNSS (A-GNSS). The determined cell locations may also be utilized to determine or calculate a location estimate for a specific mobile device. For example, the location server 150 may be operable to utilize a Cell of Origin (COO) method to identify the location of a specific mobile device. In addition, ranges to corresponding base stations in one or more reported neighbor cells for the specific mobile device may be determined or estimated utilizing the learned cell data.

The SRN 160 may comprise suitable logic, circuitry and/or code that may be operable to collect and distribute data for GNSS satellites on a continuous basis. The SRN 160 may comprise a plurality of GNSS reference tracking stations located around the world to provide A-GNSS coverage all the time in both a home network and/or any visited network. This allows users of mobile devices such as the mobile devices 114-138 to roam with associated LBS anywhere in the world. The SRN 160 may be operable to ensure high levels of availability, performance and reliability for LBS.

The GNSS satellites 172 through 176 may comprise suitable logic, circuitry and/or code that may be operable to generate and broadcast satellite navigational information in suitable radio-frequency (RF) signals to various GNSS capable communication devices such as, the mobile devices 114-116. The broadcast satellite navigational information may be utilized to support LBS services. The GNSS satellites 172 through 176 may be GPS, Galileo, and/or GLONASS satellites.

In an exemplary operation, a mobile device such as the mobile device 114 in the cell 110 may be operable to learn or capture cell information on a serving cell (the cell 110) and one or more neighbor cells such as the cells 120-130 to facilitate cell-learning. Received signal strength on both the serving cell (the cell 110) and neighbor cells such as the cells 120-130 may be measured by the mobile device 114. The mobile device 114 may run the cell-learning client 114a to associate the RSS measurements with corresponding locations for location-based RSS measurements. The location-based RSS measurements together with other captured cell information such as, for example, cell operating frequencies, Cell-IDs, MCC and/or MNC may be utilized to generate a NCR to build the local cell-learning database 114b. The mobile device 114 may be operable to transmit at least a portion of the local cell-learning database 114b as cell data to the location server 150. The location server 150 may be operable to collect or learn cell data from a plurality of mobile devices such as the mobile devices 114-138. The learned cell data may be utilized to build or refine the central cell-learning database 150a. The location server 150 may be operable to determine or calculate locations for reported cells utilizing the stored cell data in the central cell-learning database 150a. In this regard, the location server 150 may be operable to determine locations of reported cells independently without utilizing location based services offered by wireless operator. The determined cell locations may be utilized as reference locations to support A-GNSS operations and/or to calculate an actual location estimate for a specific mobile device whenever needed. Furthermore, the location server 150 may be operable to utilize the stored cell data to determine or estimate ranges to corresponding base stations in reported neighbor cells for the specific mobile device whenever needed.

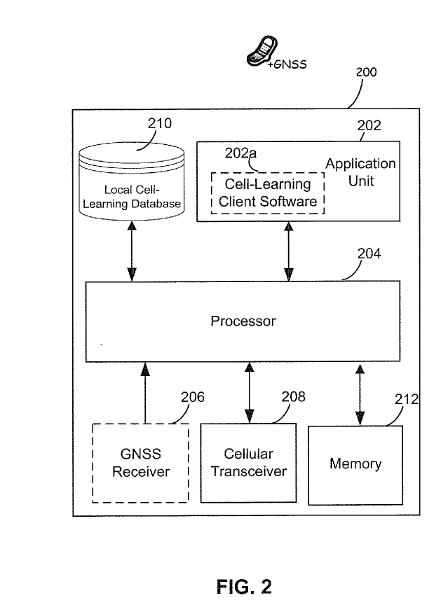

FIG. 2 is a diagram illustrating an exemplary mobile device that is operable to provide cell data to a cell-learning database for neighbor cell positioning, in accordance with an embodiment of the invention. Referring to FIG. 2, there is shown a mobile device 200 comprising an application unit 202, a processor 204, a GNSS receiver 206, a cellular transceiver 208, a local cell-learning database 210 and a memory 212.

The application unit 202 may comprise suitable logic, circuitry, interfaces and/or code that may be operable to manage various application requirements such as application QoS attributes. The application unit 202 may comprise application software such as cell-learning software 202a utilized to perform various cell-learning tasks such as, for example, location-stamping RSS measurements and/or generating neighbor cell reports.

The processor 204 may comprise suitable logic, circuitry, interfaces and/or code that may be operable to manage and/or coordinate operations of device component units such as, for example, the GNSS receiver 206, the cellular transceiver 208 and/or the local cell-learning database 210. For example, the processor 204 may be operable to activate the cellular transceiver 208 to take or collect RSS measurements on both a serving cell (the cell 110) and neighbor cells such as the cells 120-130. In various embodiments of the invention, the processor 204 may be operable to run the cell-learning client software 202a to associate the RSS measurements with corresponding locations where the RSS measurements are performed. In instances where the mobile device 200 is GNSS capable, the processor 204 may be operable to coordinate operations of the GNSS receiver 206 and the cellular transceiver 208 so as to determine or calculate locations pertaining to the corresponding RSS measurements. In instances where the mobile device 200 is not GNSS capable, the processor 204 may be operable to determine or calculate locations pertaining to the corresponding RSS measurements through non-GNSS means such as, for example, locating the mobile device 200 utilizing cellular network data. The processor 204 may be operable to location stamp the RSS measurements utilizing the corresponding determined locations to form or produce location-based RSS measurements. The location-based RSS measurements together with other cell information such as, for example, cell operating frequencies, cell identifiers (Cell-IDs), Country Code (MCC) and/or Mobile Network Code (MNC) may be utilized by the processor 204 to generate a NCR. The generated NCR may be communicated, by the cellular transceiver 208, to the cellular core network 140 to support network operations when needed. For example, the processor 204 may be operable to transmit the generated NCR to the cellular core network 140 as a NMR (in 2G) or a MRL (in 3G) to prepare a handover operation for the mobile device 200 from the serving cell (the cell 110) to a reported neighbor cell such as the cell 120. The processor 204 may also be operable to utilize the generated NCR to build the local cell-learning database 210. In this regard, at least a portion of the cell-learning database 210 may be uploaded as cell data to the central location processing unit 150. The format of the uploaded cell data may be compatible with the cellular core network 140. The uploaded cell data may be utilized to determine or calculate locations for reported cells to enhance the central cell-learning database 150a. The processor 204 may receive the determined locations for the reported cells from the location server 150 whenever needed.

The GNSS receiver 206 may comprise suitable logic, circuitry, interfaces and/or code that may be operable to detect and receive GNSS signals from a plurality of visible GNSS satellites such as the GNSS satellite 172-176. The GNSS receiver 206 may be operable to extract GNSS satellite navigation information such as ephemeris of broadcasting GNSS satellites from the received GNSS signals. The extracted ephemeris may be communicated to the processor 204 for further processing. In some embodiments of the invention, the GNSS receiver 206 may be an optional device component unit for the mobile device 200.

The cellular transceiver 208 may comprise suitable logic, circuitry, interfaces and/or code that may be operable to transmit and/or receive radio signals in cellular spectrum. The radio signals transmitted and/or received may be processed via the processor 204. In this regard, the cellular transceiver 208 may be configured to perform RSS measurements at particular locations on a serving cell as well as one or more neighbor cells. The RSS measurements may be location stamped and communicated to the processor 204 for further processing.

The local cell-learning database 210 may comprise suitable logic, circuitry, interfaces and/or code that may be operable to manage and store data comprising learned or captured serving and neighbor cell information such as, for example, cell operating frequencies, Cell-IDs, location-based RSS measurements, MCC and/or MNC. Contents in the local-learning database 210 may be indexed by a cell attribute parameter that indicates whether a corresponding cell is a serving cell or a neighbor cell. In instances where a cell is a serving cell, contents associated with the serving cell may be marked as more accurate. In instances where a cell is a neighbor cell, contents associated with the neighbor cell may be marked as less accurate. The local cell-learning database 210 may be updated or refined on an as needed basis, periodically, or aperiodically.

The memory 212 may comprise suitable logic, circuitry, interfaces and/or code that may be operable to store information such as executable instructions, configuration information and data that may be utilized by the processor 204 and/or other associated component units such as, for example, the GNSS receiver 206 and/or the cellular transceiver 208. The memory 212 may comprise RAM, ROM, low latency nonvolatile memory such as flash memory and/or other suitable electronic data storage.

In an exemplary operation, the processor 204 may be operable to measure received signal strength (RSS) on both a serving cell (the cell 110) and neighbor cells such as the cells 120-130. The processor 204 may run the cell-learning client software 202a to associate the RSS measurements with corresponding locations where the RSS measurements are performed. The processor 204 may be operable to determine or calculate locations pertaining to the RSS measurements via GNSS or non-GNSS means depending on device capabilities. The processor 204 may utilize the location-based RSS measurements together with other learned cell information such as, for example, cell operating frequencies, Cell-IDs, MCC and/or MNC to generate a NCR. The generated NCR may be utilized for various applications. For example, the processor 204 may be operable to communicate the generated NCR over the cellular transceiver 208 to the cellular core network 140 to prepare a handover operation for the mobile device 200. The processor 204 may also utilize the generated NCR to build the local cell-learning database 210. In the local cell-learning database 210, contents associated with a reported serving cell may be flagged or marked as more accurate. Contents associated with a reported neighbor cell may be flagged or marked as less accurate. At least a portion of the cell-learning database 210 may be regularly or as needed uploaded as cell data to the central location processing unit 150. The format of the uploaded cell data may be compatible with the cellular core network 140.

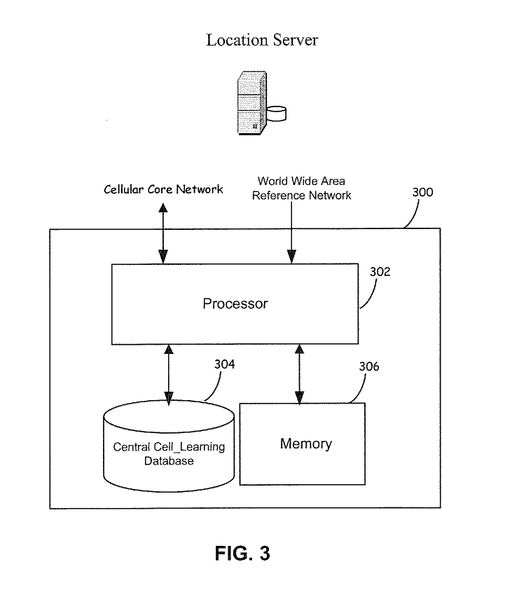

FIG. 3 is a diagram illustrating an exemplary location server that is operable to locate neighbor cells using learned cell data provided by associated mobile devices, in accordance with an embodiment of the invention. Referring to FIG. 3, there is shown a location server 300. The location server 300 comprises a processor 302, a central cell-learning database 304 and a memory 306.

The processor 302 may comprise suitable logic, circuitry, interfaces and/or code that may be operable to access the SRN 160 to collect GNSS satellite data by tracking GNSS constellations through the SRN 160. The processor 302 may be operable to utilize the collected GNSS satellite data, for example, to build the central cell-learning database 304. In this regard, the processor 302 may be operable to receive and/or learn cell data from a plurality of mobile devices via the cellular core network 140. The learned cell data may comprise cell information for both serving cell as well as neighbor cells. For example, the cell information may comprise cell operating frequencies, Cell-IDs, location-based RSS measurements, MCC and/or MNC. The processor 302 may be operable to utilize the learned cell data to build or update the central cell-learning database 304. Contents associated with a reported serving cell may be flagged or marked as more accurate compared to contents associated with a reported neighbor cell.

The processor 302 may be operable to utilize the learned cell data in the central cell-learning database 304 to determine or calculate locations for reported cells of interest. In this regard, the processor 302 may determine or calculate cell locations independently without using location based services provided by a wireless operator. The determined cell locations may be utilized as reference locations to support assistance GNSS (A-GNSS). The determined cell locations may also be utilized to determine or calculate a location estimate for a specific mobile device utilizing, for example, a COO method. Moreover, the learned cell data may be utilized to calculate or estimate ranges to corresponding base stations in reported neighbor cells for the specific mobile device whenever needed. The processor 302 may utilize the calculated cell locations and/or ranges to refine the central cell-learning database 304. The processor 302 may be operable to communicate message in exemplary formats that are compatible with the cellular core network 140. For example, the processor 302 may be operable to support messaging in RRLP format, PCAP interface and/or OMA SUPLv1.0. The processor 302 may be configured to communicate with associated mobile devices such as the mobile devices 114-138 in either a user-plane or a control-plane for cell data periodically or aperiodically.

The central cell-learning database 304 may comprise suitable logic, circuitry, interfaces and/or code that may be operable to manage and/or store data comprising reference positions and/or cell location information learned from a plurality of associated mobile devices. In this regard, the central cell-learning database 304 may be refined or updated using cell locations that are derived or calculated using corresponding learned cell data. The contents in the central cell-learning database 304 may be updated as a needed or periodically.

The memory 306 may comprise suitable logic, circuitry, interfaces and/or code that may be operable to store information comprising executable instructions, and configuration information, that may be utilized by the processor 302. The executable instructions may comprise algorithms that may be utilized to calculate cell locations utilizing corresponding learned cell data. The memory 306 may comprise RAM, ROM, low latency nonvolatile memory such as flash memory and/or other suitable electronic data storage.

In operation, the processor 302 may be operable to receive and/or learn cell data regularly from a plurality of mobile devices via the cellular core network 140. The learned cell data may comprise serving cell information as well as neighbor cell information. The learned cell data may be utilized to build the central cell-learning database 304, where contents associated with a reported serving cell may be marked as more accurate compared to contents associated with a reported neighbor cell. The processor 302 may utilize the learned cell data to determine or calculate cell locations independently without utilizing location based services offered by a wireless operator. An actual location estimate for a specific mobile device may be calculated based on the determined cell locations. Ranges to base stations in corresponding reported neighbor cells may be estimated or calculated utilizing the learned cell data for the specific mobile device whenever needed. The determined cell locations and/or ranges may be utilized to refine the central cell-learning database 304. The processor 302 may be operable to provide at least a portion of the central cell-learning database 304 to mobile devices such as the mobile devices 114-138.

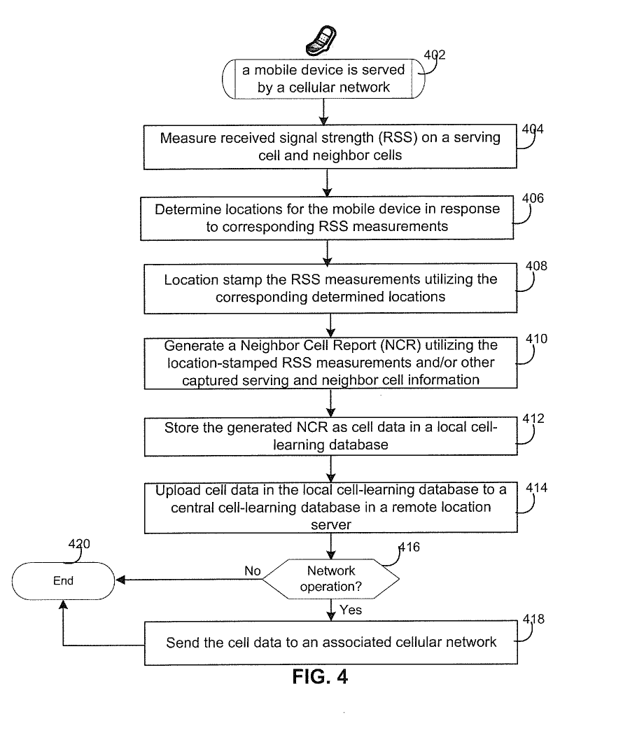

FIG. 4 is a diagram illustrating exemplary steps utilized by a mobile device to generate Neighbor Cell Reports to build a cell-learning database, in accordance with an embodiment of the invention. Referring to FIG. 4, the exemplary steps start with step 402, where a mobile device such as the mobile device 200 is being served in the cell 100 that is associated with the cellular core network 140. In step 404, the mobile device 200 may be operable to measure received signal strength (RSS) for a serving cell (the cell 110) and neighbor cells such as the cells 120-130. In step 406, the mobile device 200 may be operable to determine locations pertaining to corresponding RSS measurements. Depending device capabilities, the locations may be determined via GNSS means or non-GNSS means. In step 408, the mobile device 200 may be operable to location stamp the RSS measurements utilizing the corresponding determined locations. In step 410, the mobile device 200 may be operable to generate a neighbor cell report (NCR) utilizing the location-stamped RSS measurements and/or other captured serving and neighbor cell information such as, for example, cell operating frequencies, Cell-IDs, MCC and/or MNC.

In step 412, the mobile device 200 may be operable to store the generated NCR as cell data in the local cell-learning database 210. In step 414, the mobile device 200 may be configured to upload at least a portion of the local cell-learning database 210 as cell data to the central cell-learning database 304 in a remote location server such as the location server 300. In step 416, it may be determined whether cell information may be needed to support network operations such as a handover operation. In instances where cell information may be needed to support network operations, then in step 418, the mobile device 200 may be operable to send or communicate the stored cell data as, for example, as a Network Measurement Report (NMR) (in 2G) or a Measurement Report List (MRL) (in 3G), to the cellular core network 140. The exemplary steps may end in step 420. In step 416, in instances where cell information may not be needed to support network operations, then the exemplary steps may end in step 420.

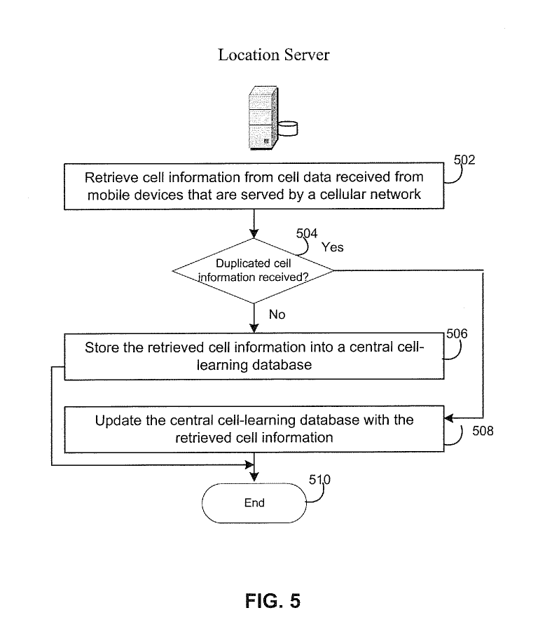

FIG. 5 is a diagram illustrating exemplary steps utilized by a location server to collect cell data from mobile devices in a cellular network to build a central cell-learning database, in accordance with an embodiment of the invention. Referring to FIG. 5, the exemplary steps start with step 502, the location server 300 may be operable to retrieve or learn cell information from cell data received from mobile devices that are served by the cellular core network 140. In step 504, it may be determined whether duplicated cell information is received. In instances where the retrieved cell information already exists in the central cell-learning database 304, then in step 508, the location server 300 may be operable to utilize the retrieved cell information to update the central cell-learning database 304. The exemplary steps may end in step 510.

In step 504, in instances where the retrieved cell information does not exist in the central cell-learning database 304, then in step 506, the location server 300 may be operable to store the retrieved cell information in the central cell-learning database 304. The exemplary steps may end in step 510.

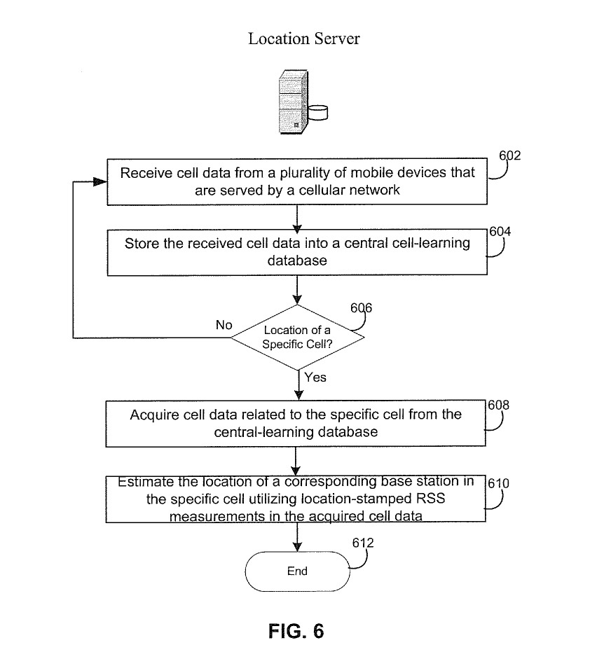

FIG. 6 is a diagram illustrating exemplary steps utilized by a location server to locate a specific cell utilizing corresponding cell data received from mobile devices in a cellular network, in accordance with an embodiment of the invention. Referring to FIG. 6, the exemplary steps start with step 602, the location server 300 may be operable to receive cell data from a plurality of mobile devices that are served by the cellular core network 140. In step 604, the received cell data may be stored in the central cell-learning database 304. In step 606, it may be determined whether a location of a corresponding base station in a specific cell may be required. In instances where the location for the specific cell is required to support a LBS application, for example, then in step 608, the location server 300 may be operable to acquire cell data related to the specific cell from the central-learning database 304. In step 610, the location of the corresponding base station in the specific cell may be estimated utilizing location-stamped RSS measurements in the acquired cell data. The exemplary steps may end in step 612. In step 606, in instances where the location of the corresponding base station in the specific cell is not required, then the exemplary steps may return to step 602.

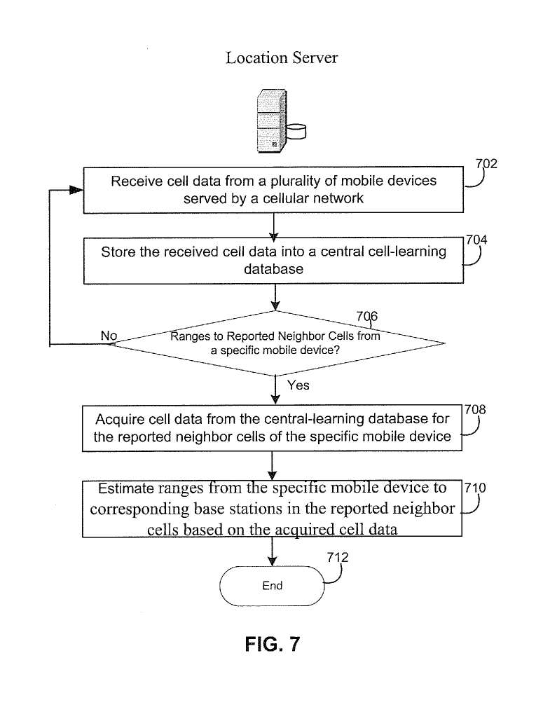

FIG. 7 is a diagram illustrating exemplary steps utilized by a location server to determine ranges to corresponding base stations in reported neighbor cells for a specific mobile device, in accordance with an embodiment of the invention. Referring to FIG. 7, the exemplary steps start with step 702, the location server 300 may be operable to receive cell data from a plurality of mobile devices that are served by the cellular core network 140. In step 704, the received cell data may be stored in the central cell-learning database 304. In step 706, it may be determined whether ranges to corresponding base stations in reported neighbor cells from a specific mobile device may be needed. In instances where the ranges to corresponding base stations in reported neighbor cells from the specific mobile device are needed, then in step 708, the location server 300 may be operable to acquire cell data for the reported neighbor cells of the specific mobile device from the central-learning database 304. In step 710, the ranges from the specific mobile device to corresponding base stations in the reported neighbor cells may be estimated based on the acquired cell data. The exemplary steps may end in step 712. In step 706, in instances where the ranges to corresponding base stations in reported neighbor cells from the specific mobile device are not needed, then the exemplary steps may return to step 702.

Aspects of a method and system for positioning neighbor cells in a cellular network using learned cell data are provided. In accordance with various exemplary embodiments of the invention, as described with respect to FIG. 1 through FIG. 7, a mobile communication device such as the mobile device 200 may be operable to collect or learn cell information for a serving cell and for one or more neighbor cells of the mobile device 200. The learned cell information may be transmitted or communicated to a remote location server such as the location server 300. The location server 300 may be operable to utilize the learned cell information to determine a location of a corresponding base station in the serving cell and/or to determine locations of corresponding base stations within the one or more neighbor cells. The mobile device 200 is operable to receive the location of a corresponding base station in the serving cell and/or corresponding base stations within the one or more neighbor cells. The learned cell information comprises cell signal strength information and other cell information such as, for example, cell operating frequencies, cell identifiers (Cell-IDs), Country Code (MCC), and/or Mobile Network Code (MNC). In this regard, the mobile device 200 may be operable to learn cell signal strength information by measuring RSS on the serving cell such as the cell 110 and the neighbor cells such as the cells 120-130. Locations pertaining to the RSS measurements may be determined or calculated through GNSS or non-GNSS means based on device capabilities.

The mobile device 200 may be operable to run the cell-learning software 202a to location stamp the RSS measurements utilizing the determined locations. The mobile device 200 may utilize the location-stamped RSS measurements together with other captured cell information such as Cell-IDs to generate a neighbor cell report. The generated neighbor cell report may be utilized for various applications. For example, the mobile device 200 may be operable to communicate the generated neighbor cell report to the cellular core network 140 to prepare a handover operation for the mobile device 200 whenever needed. In addition, the generated neighbor cell report may be utilized to build the local cell-learning database 210. In this regard, at least a portion of the local cell-learning database 210 may be transmitted or communicated as cell data to the location server 300 to build or refine the central cell-learning database 304. The location server 300 may be operable to collect cell data from a plurality of mobile devices. The collected cell data may be utilized to determine locations of corresponding base station within cells reported in the collected cell data independently without the participation of a wireless operator.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for positioning neighbor cells in a cellular network using learned cell data.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method of processing signals, the method comprising:
in a mobile device:
learning cell information for a serving cell and for one or more neighbor cells of said serving cell;
communicating said learned cell information to a remote location server; and
receiving from said remote location server, a location of a corresponding base station within said serving cell and/or locations of one or more corresponding base stations within said one or more neighbor cells, wherein said location of said corresponding base station within said serving cell and said location of said one or more corresponding base stations within said one or more neighbor cells is determined based on said communicated learned cell information.

2. The method according to claim 1, comprising measuring received signal strength (RSS) on said serving cell and said one or more neighbor cells.

3. The method according to claim 2, comprising determining locations pertaining to said RSS measurements.

4. The method according to claim 3, comprising location stamping said RSS measurements utilizing said determined locations.

5. The method according to claim 4, comprising generating a neighbor cell report utilizing said location-stamped RSS measurements.

6. The method according to claim 5, wherein said generated neighbor cell report comprises cell operating frequencies, cell identifiers (Cell-IDs), Country Code (MCC), Mobile Network Code (MNC) and/or said location-stamped RSS measurements.

7. The method according to claim 5, comprising utilizing said generated neighbor cell report to support an associated cellular network operation.

8. The method according to claim 5, comprising utilizing said generated neighbor cell report to build a local cell-learning database that is locally accessible by said mobile device.

9. The method according to claim 8, comprising communicating at least a portion of said local cell-learning database as cell data to said remote location server.

10. The method according to claim 9, wherein said remote location server collects cell data from a plurality of mobile devices to determine locations of corresponding base stations within cells reported in the collected cell data.

11. A system for processing signals, the system comprising:
one or more processors and/or circuits for use in a mobile device, said one or more processor being operable to:
learn cell information for a serving cell and for one or more neighbor cells of said mobile device;
communicate said learned cell information to a remote location server; and
receive from said remote location server, a location of a corresponding base station within said serving cell and/or location of one or more corresponding base stations within said one or more neighbor cells, wherein said location of said corresponding base station within said serving cell and said location of said one or more corresponding base stations within said one or more neighbor cells is determined based on said communicated learned cell information.

12. The system according to claim 11, wherein said one or more processors and/or circuits are operable to measure received signal strength (RSS) on said serving cell and said one or more neighbor cells.

13. The system according to claim 12, wherein said one or more processors and/or circuits are operable to determine locations pertaining to said RSS measurements.

14. The system according to claim 13, wherein said one or more processors and/or circuits are operable to location stamp said RSS measurements utilizing said determined locations.

15. The system according to claim 14, wherein said one or more processors and/or circuits are operable to generate a neighbor cell report utilizing said location-stamped RSS measurements.

16. The system according to claim 15, wherein said generated neighbor cell report comprises cell operating frequencies, cell identifiers (Cell-IDs), Country Code (MCC), Mobile Network Code (MNC) and/or said location-stamped RSS measurements.

17. The system according to claim 15, wherein said one or more processors and/or circuits are operable to utilize said generated neighbor cell report to support an associated cellular network operation.

18. The system according to claim 15, wherein said one or more processors and/or circuits are operable to utilize said generated neighbor cell report to build a local cell-learning database that is locally accessible by said mobile device.

19. The system according to claim 18, wherein said one or more processors and/or circuits are operable to communicate at least a portion of said local cell-learning database as cell data to said remote location server.

20. The system according to claim 19, wherein said remote location server collects cell data from a plurality of mobile devices to determine locations of corresponding base stations within cells reported in the collected cell data.
